(19) United States
(12) Patent Application Publication
(10) Pub. No.: US 2013/0185920 A1
(43) Pub. Date: Jul. 25, 2013

(54) ANCHOR DEVICE AND METHOD OF USE

(71) Applicant: Amir PELED, Netanya (IL)

(72) Inventor: Amir PELED, Netanya (IL)

(21) Appl. No.: 13/558,719

(22) Filed: Jul. 26, 2012

Related U.S. Application Data
(63) Continuation-in-part of application No. 13/111,090, filed on May 19, 2011.
(60) Provisional application No. 61/376,684, filed on Aug. 25, 2010.

(51) Int. Cl. F16B 39/22

(52) U.S. Cl. CPC F16B 39/22
USPC 29/525.02; 411/57.1

(57) ABSTRACT

An anchor apparatus for insertion into a pre-formed hole in an object of interest for permanent embedment in the hole. The apparatus includes: a screw pair having: (i) a screw with a screw head and (ii) a nut threadly interconnected therebetween; an anchor with a distal part and a proximal part to be received and anchored in the hole, the anchor comprising at least two fixing petals extendable from the outer perimeter of the distal part of the anchor; and a pushing tubular member with a distal part and a proximal part, the distal part of said tubular member adapted to expand said fixing petals of the anchor.

### REFERENCE TO RELATED APPLICATIONS

This application is a Continuation-In-Part of U.S. patent application Ser. No. 13/111,090, filed on May 19, 2011, and claims priority from U.S. Provisional Patent Application No. 61/376,684, filed on Aug. 25, 2010, both of which applications are hereby incorporated by reference in their entirety.

### FIELD OF THE INVENTION

The present invention generally pertains to an apparatus and method for anchoring devices. More specifically to it relates to an expandable anchor apparatus and a method to use the anchor such that the anchor is anchored in a pre-formed hole.

### BACKGROUND OF THE INVENTION

It is a long felt need to provide an anchoring device which is independent of a securing nut, disposed on the other side of an object or wall.

It is further a long felt need to provide an anchoring device which is independent of the dimensions of the hole, in which it is anchored.

### SUMMARY OF THE INVENTION

It is one object of the present invention to disclose an anchor device [100] for securing a screw [110] and a load to an object [310] through or within a pre-formed hole [320] comprising:
a. a threaded screw [110];
b. a tubular member [120], comprising a grip head [125] at one end, configured to contain said screw's head [115] and to allow the rotation of said screw's head [115]; and
c. at least one threaded tubular anchor [130], each of said anchors [130]

comprising at least two spreadable fixing-petals [135] located at one end; said member [120] is seated on said screw [110] with said grip head [125] towards said screw's head [115]; said anchors [130] are seated on said screw [110], following said member [120] and in contact with said member [120] or in contact with said other anchor [130], where said fixing-petals [135] are seated towards said screw's head [115];

wherein said member [120] further comprises a guiding-edge [126] at the opposing end, adapted to open said anchor's fixing-petals [135], while compression forces are activated therebetween; said anchors [130] further comprise a guiding-edge [136] at the opposing end, adapted to open said following anchor's fixing-petals [135], while said compression forces are activated therebetween; said screw's head [115] and said anchors [130] are configured to threadly approach each other, during said screw's [110] rotation, thus creating said compression forces and opening said anchors' fixing-petals [135]; said opened anchor's fixing-petals [135] are adapted to firmly cling said screw [110] to said object [310], by hanging onto the surface inside of said hole [320] or onto the surface at the back of said object [310], thereby securing said screw [110] and said load to said object [310]; further wherein said anchor device [100] is configured for functionality without a securing nut.

It is another object of the present invention to disclose the anchor device [100] as defined above, wherein said anchor [130] is constructed of a tube with at least two slots at one end of said tube, thereby said slots creating said at least two fixing-petals [135].

It is another object of the present invention to disclose the anchor device [100] as defined above, wherein said member's guiding-edge [126] is consisting of a shape selected from the group comprising of: cone, truncated-cone, sphere, truncated-sphere, cylinder, polygon, or any combination thereof.

It is another object of the present invention to disclose the anchor device [100] as defined above, wherein said member's guiding-edge [126] is further consisting of at least two protruding tips [330] or at least two concaved guide-paths [220], adapted to open said anchor's matching fixing-petals [135] and slide said fixing-petals [135] along said guiding-edge [126].

It is another object of the present invention to disclose the anchor device [100] as defined above, wherein said anchor's guiding-edge [136] is consisting of a shape selected from the group comprising of: cone, truncated-cone, sphere, truncated-sphere, cylinder, polygon, or any combination thereof.

It is another object of the present invention to disclose the anchor device [100] as defined above, wherein said anchor's guiding-edge [136] is further consisting of at least two protruding tips [330] or at least two concaved guide-paths [230], adapted to open said following anchor's matching fixing-petals [135] and slide said fixing-petals along said anchor's guiding-edge [136].

It is another object of the present invention to disclose the anchor device [100] as defined above, wherein the ends of said anchor's fixing-petals [135] are beveled at their inner side, for a smother slide along said member's guiding-edge [126] and for an easier penetration into the surface inside of said hole [320] or into the surface at the back of said object [310].

It is another object of the present invention to disclose the anchor device [100] as defined above, wherein said device [100] comprises a single said anchor [130], said anchor constructed without said guiding edge [136] at said opposing end [610].

It is another object of the present invention to disclose the anchor device [100] as defined above, wherein said device [100] is configured in different diameters and lengths, adapted to carry different loads, and to go through different hole [320] lengths.

It is another object of the present invention to disclose the anchor device [100] as defined above, wherein said device [100] is made of a material selected from a group consisting of: metal composite, alloy composite, plastic composite, steel, iron, aluminum, copper composite, or any combination thereof.

It is another object of the present invention to disclose the anchor device [100] as defined above, wherein said inner side of said fixing-petals [135] and the outer of side of said guiding-edge [126,136] of said tubular member [120] or said anchor [130] are made of materials with a static friction coefficient of between about 0.5 and about 0.8.

It is another object of the present invention to disclose the anchor device [100] as defined above, wherein said anchor device [100] is further provided with a centering collar [860].

It is another object of the present invention to disclose the anchor device [100] as defined above, wherein said object [310] is a wall; said wall is a selected from a group consisting of a concrete wall, a gypsum wall, a block wall, a brick wall, a stone wall, or any combination thereof.

It is another object of the present invention to disclose a method for securing a screw [110] and a load to an object [310] through or within a pre-formed hole [320] comprising the step of:
a. obtaining an anchor device [100] comprising:
   i. a threaded screw [110];
   ii. a tubular member [120], comprising a plier-grip head [125] at one end, configured to contain said screw's head [115] and to allow the rotation of said screw's head [115]; said member [120] further comprises a guiding-edge [126] at the opposing end, adapted to open said anchor's fixing-petals [135], while compression forces are activated therebetween; and
   iii. at least one threaded tubular anchor [130], each of said anchors [130] comprising at least two spreadable fixing-petals [135] located at one end; said anchors [130] further comprise a guiding-edge at the opposing end, adapted to open said following anchor's fixing-petals [135], while said compression forces are activated therebetween;
      wherein, said method further comprises the steps of:
b. locating said member [120] on said screw [110] with said grip-head [125] towards said screw's head [115];
c. locating said anchors [130] said screw [110], following said member [120] and in contact with said member [120] or in contact with said other anchor [130], where said fixing-petals [135] are seated towards said screw's head [115];
d. inserting said anchor device [100] into said hole [320] or through said hole [320];
e. screwing said screw's head [115], while holding said members grip-head [125], so as said screw's head [115] and said anchors [130] are threadly approaching each other;
f. pushing said tubular member [130] towards said anchor's fixing-petals [135], thereby creating said compression forces;
g. sliding said anchor's fixing-petals [135] along the body of said member's guiding-edge [126] or along the previous anchor's guiding edge [136];
h. opening said anchors' fixing-petals [135] and pushing away said anchors' fixing-petals [135] from said screw [110], by said compression forces; and
i. clinging said opened anchor's fixing-petals [135] onto the surface inside of said hole [320] or onto the surface at the back of said object [310], thereby securing said screw [110] and said load to said object [310].

It is another object of the present invention to disclose the method as defined above, wherein said anchor [130] is constructed of a tube with at least two slots at one end of said tube, thereby said slots creating said at least two fixing-petals [135].

It is another object of the present invention to disclose the method as defined above, wherein said member's guiding-edge [126] is consisting of a shape selected from the group comprising of: cone, truncated-cone, sphere, truncated-sphere, cylinder, polygon, or any combination thereof.

It is another object of the present invention to disclose the method as defined above, wherein said member's guiding-edge [126] is further consisting of at least two protruding tips [330] or at least two concaved guide-paths [220], adapted to open said anchor's matching fixing-petals [135] and slide said fixing-petals [135] along said guiding-edge [126].

It is another object of the present invention to disclose the method as defined above, wherein said anchor's guiding-edge [136] is consisting of a shape selected from the group comprising of: cone, truncated-cone, sphere, truncated-sphere, cylinder, polygon, or any combination thereof.

It is another object of the present invention to disclose the method as defined above, wherein said anchor's guiding-edge [136] is further consisting of at least two protruding tips [330] or at least two concaved guide-paths [230], adapted to open said following anchor's matching fixing-petals [135] and slide said fixing-petals [135] along said anchor's guiding-edge [136].

It is another object of the present invention to disclose the method as defined above, wherein the ends of said anchor's fixing-petals [135] are beveled at their inner side, for a smother slide along said member's guiding-edge [126] and for an easier penetration into the surface inside of said hole [320] or into the surface at the back of said object [310].

It is another object of the present invention to disclose the method as defined above, wherein said device [100] comprises a single said anchor [130], said anchor constructed without said guiding edge [136] at said opposing end [610].

It is another object of the present invention to disclose the method as defined above, wherein said device [100] is configured in different diameters and lengths, adapted to carry different loads, and to go through different hole [320] lengths.

It is another object of the present invention to disclose the method as defined above, wherein said device [100] is made of a material selected from a group consisting of: metal composite, alloy composite, plastic composite, steel, iron, aluminum, copper composite, or any combination thereof.

It is another object of the present invention to disclose the method as defined above, wherein said inner side of said fixing-petals [135] and the outer of side of said guiding-edge [126,136] of said tubular member [120] or said anchor [130] are made of materials with a static friction coefficient of between about 0.5 and about 0.8.

It is another object of the present invention to disclose the method as defined above, wherein said anchor device [100] is further provided with a centering collar [860].

It is another object of the present invention to disclose the method as defined above, wherein said object [310] is a wall; said wall is a selected from a group consisting of a concrete wall, a gypsum wall, a block wall, a brick wall, a stone wall, or any combination thereof.

It is another object of the present invention to disclose an anchor device [800] for securing a screw [110] and a load to an object [310] within a pre-formed hole [320] comprising:
a. a threaded screw [110];
b. a first tubular anchor [820], comprising a grip head [825] at one end, configured to contain said screw's head [115] and to allow the rotation of said screw's head [115]; said first anchor [820] further comprises at least two spreadable fixing-petals [826] located the other end; and
c. a second threaded tubular anchor [830], comprising at least two spreadable fixing-petals [835] located at one end;
   said first anchor [820] is seated on said screw [110] with said grip head [825] towards said screw's head [115]; said second anchor [830] is seated on said screw [110], following said first anchor [520] and in contact with said first anchor [820], where said fixing-petals [835] of said second anchor [830] are seated towards said screw's head [115]; said first anchor [820] and said second anchor [830] comprise a matching number of said fixing-petals [826,835], thereby configured as opposing fixing-petals;
wherein each of said opposing fixing-petals [826,835] is configured with a beveled edge at their outer-side [840] or at their inner-side [850]; said fixing-petals [826,835] with said outer-side beveled edges [840] are adapted to push said fixing-petals [826,835] with said inner-side beveled edges [850] away from said screw [110], while compression forces are activated therebetween; said screw's head [115] and second anchor [830] are configured to threadly approach each other, during said screw's [110] rotation, thus creating said compression forces; said protruding opened fixing-petals [826,835] are adapted to firmly cling said screw [110] to said object [310], by hanging onto the surface inside of said hole [320], thereby securing said screw [110] and said load to said object [310]; further wherein said anchor device [800] is configured for functionality without a securing nut.

It is another object of the present invention to disclose the anchor device [800] as defined above, wherein each of said anchors [820,830] are constructed of a tube with at least two slots at one end of said tube, thereby said slots creating said at least two fixing-petals [826,835].

It is another object of the present invention to disclose the anchor device [800] as defined above, wherein said device [800] is configured in different diameters and lengths, adapted to carry different loads, and to go through different hole [320] lengths.

It is another object of the present invention to disclose the anchor device [800] as defined above, wherein said device [800] is made of a material selected from a group consisting of: metal composite, alloy composite, plastic composite, steel, iron, aluminum, copper composite, or any combination thereof.

It is still object of the present invention to disclose the anchor device [800] as defined above, wherein said anchor device [800] is further provided with a centering collar [860].

It is lastly an object of the present invention to disclose the anchor device as defined above, wherein said object [310] is a wall; said wall is a selected from a group consisting of a concrete wall, a gypsum wall, a block wall, a brick wall, a stone wall, or any combination thereof.

### BRIEF DESCRIPTION OF THE FIGURES

In order to better understand the invention and its implementation in a practice, a plurality of embodiments will now be described, by way of non-limiting example only, with reference to the accompanying drawings, in which

FIG. 1: presents a schematic illustration of the anchor device [100] of the present invention.

FIG. 2: presents a schematic illustration of the anchor device [100] parts.

FIG. 3: presents a schematic illustration of the guiding-edge [126] of the tubular member [120].

FIG. 4: presents a schematic illustration of the tubular anchor's [130] fixing-petals in an open position.

FIG. 5: presents a schematic illustration of the anchor device [100] applied through a wall, where fixing-petals [135] are in closed position.

FIG. 6: presents a schematic illustration of the anchor device [100] applied through a wall, where fixing-petals [135] are in an open position.

FIG. 7: presents a schematic illustration of the anchor device [100], with two following anchors [130], applied within an object's hole, where fixing-petals [135] are in an open position.

FIG. 8: presents a schematic illustration of an anchors device [800], comprising two opposing anchors [820,830], where fixing-petals [825,836] are in a closed position.

FIG. 9: presents a schematic illustration of the anchors device [800] comprising two opposing anchors [820,830], where fixing-petals [825,836] are in an open position.

FIGS. 10a and 10b: presents two sectional illustrations of the beveled fixing-petals [826,835] of the anchors device [800].

FIG. 11: presents a schematic illustration of the anchors device [800], applied within an object's hole, where fixing-petals [825,836] are in a closed position.

### DETAILED DESCRIPTION OF THE PREFERRED EMBODIMENTS

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

The present invention may be understood more readily by reference to the following detailed description of preferred embodiments of the invention and the examples included therein and to the Figures and their previous and following description.

The present invention discloses an anchor device [100] for securing a screw [110] and a load to an object [310] through or within a pre-formed hole [320] comprising:
a. a threaded screw [110];
b. a tubular member [120], comprising a plier grip head [125] at one end, configured to contain said screw's head [115] and to allow the rotation of said screw's head [115]; and
c. at least one threaded tubular anchor [130], each of said anchors [130]

comprising at least two spreadable fixing-petals [135] located at one end; said member [120] is seated on said screw [110] with said grip-head [125] towards said screw's head [115]; said anchors [130] are seated on said screw [110], following said member [120] and in contact with said member [120] or in contact with said other anchor [130], where said fixing-petals [135] are seated towards said screw's head [115];

wherein said member [120] further comprises a guiding-edge [126] at the opposing end, adapted to open said anchor's fixing-petals [135], while compression forces are activated therebetween; said anchors [130] further comprise a guiding-edge [136] at the opposing end, adapted to open said following anchor's fixing-petals [135], while said compression forces are activated therebetween; said screw's head [115] and said anchors [130] are configured to threadly approach each other, during said screw's [100] rotation, thus creating said compression forces and opening said anchors' fixing-petals [135]; said opened anchor's fixing-petals [135] are adapted to firmly cling said screw [110] to said object [310], by hanging onto the surface inside of said hole [320] or onto the surface at the back of said object [310], thereby securing said screw [110] and said load to said object [310]; further wherein said anchor device [100] is configured for functionality without a securing nut.

The present invention further discloses a method for securing a screw [110] and a load to an object [310] through or within a pre-formed hole [320] comprising the step of:
a. obtaining an anchor device [100] comprising:
   i. a threaded screw [110];
   ii. a tubular member [120], comprising a plier-grip head [125] at one end, configured to contain said screw's head [115] and to allow the rotation of said screw's head [115]; said member [120] further comprises a guiding-edge [126] at the opposing end, adapted to open said anchor's fixing-petals [135], while compression forces are activated therebetween; and
   iii. at least one threaded tubular anchor [130], each of said anchors comprising at least two spreadable fixing-petals [135] located at one end; said anchors [130] further comprise a guiding-edge [136] at the opposing end, adapted to open said following anchor's fixing-petals [135], while said compression forces are activated therebetween;
      wherein, said method further comprises the steps of:
b. locating said member [120] on said screw [110] with said grip-head [125] towards said screw's head [115];
c. locating said anchors [130] said screw [110], following said member [120] and in contact with said member [120] or in contact with said other anchor [130], where said fixing-petals [135] are seated towards said screw's head [115];
d. inserting said anchor device [100] into said hole [320] or through said hole [320];
e. screwing said screw's head [115], while holding said members grip-head [125], so as said screw's head [115] and said anchors [130] are threadly approaching each other;
f. pushing said tubular member [130] towards said anchor's fixing-petals [135], thereby creating said compression forces;
g. sliding said anchor's fixing-petals [135] along said member's guiding-edge or along the previous anchor's guiding edge [136];
h. opening said anchors' fixing-petals [135] and pushing away said anchors' fixing-petals [135] from said screw [110], by said compression forces; and
i. clinging said opened anchor's fixing-petals [135] onto the surface inside of said hole [320] or onto the surface at the back of said object [310], thereby securing said screw [110] and said load to said object [310].

Moreover, the effect is highly useful in cases in which the surface of the hole [320] can fall to pieces or collapse, if an anchor [130] rotates inside the surface during the process anchoring. This undesirable rotation can enlarge the hole [320], and even damage the hole [320] making it inappropriate for installation of the anchor [130]. The anchor device [100] of the present invention does not depend on the hole's [320] dimensions. The anchor device [100] of the present invention does not use the surface of the hole [320] in order not to turn inside the wall during the anchoring. This advantage over the anchors known in the prior art is critical, in many cases, for proper installation of an anchor in the hole. During the anchoring of the anchors known in the prior art, it also a common event when the anchor is damaged after being rotated inside the hole during the anchoring.

The advantage of the anchor device [100] of the present described above prevents the damages that can be caused to the anchor during the anchoring process.

Moreover, the anchor device [100] of the present invention is independent of the dimensions of the hole [200] in which it is anchored, which means that the pre-formed hole [320] can be wider and longer than the diameter or length of the anchor device [100]. During the process of the expansion, the anchor [130] will adapt itself to the size of the hole [320].

An anchor device [800] for securing a screw [110] and a load to an object [310] within a pre-formed hole [320] comprising:
a. a threaded screw [110];
b. a first tubular anchor [820], comprising a plier-grip head [825] at one end, configured to contain said screw's head [115] and to allow the rotation of said screw's head [115]; said first anchor [820] further comprises at least two spreadable fixing-petals [826] located the other end; and
c. a second threaded tubular anchor [830], comprising at least two spreadable fixing-petals [835] located at one end;
   said first anchor [820] is seated on said screw [110] with said grip-head [825] towards said screw's head [115]; said second anchor [830] is seated on said screw [110], following said first anchor [520] and in contact with said first anchor [820], where said fixing-petals [835] of said second anchor [830] are seated towards said screw's head [115]; said first anchor [820] and said second anchor [830] comprise a matching number of said fixing-petals [826, 835], thereby configured as opposing fixing-petals;

wherein each of said opposing fixing-petals [826,835] is configured with a beveled edge at their outer-side [840] or at their inner-side [850]; said fixing-petals [826,835] with said outer-side beveled edges [840] are adapted to push said fixing-petals [826,835] with said inner-side beveled edges [850] away from said screw [110], while compression forces are activated therebetween; said screw's head [115] and second anchor [830] are configured to threadly approach each other, during said screw's [110] rotation, thus creating said compression forces; said protruding fixing-petals are adapted to firmly cling said screw [110] to said object [310], by hanging onto the surface inside of said hole [320], thereby securing said screw [110] and said load to said object [310]; further wherein said anchor device [800] is configured for functionality without a securing nut.

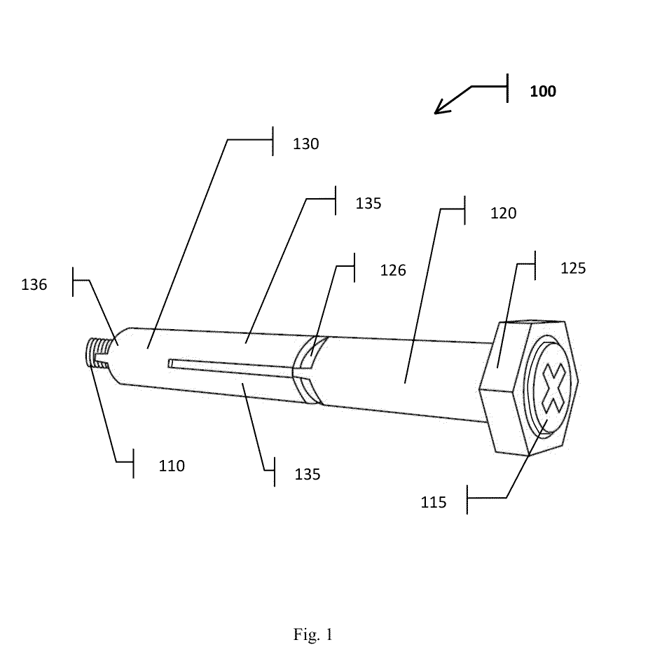

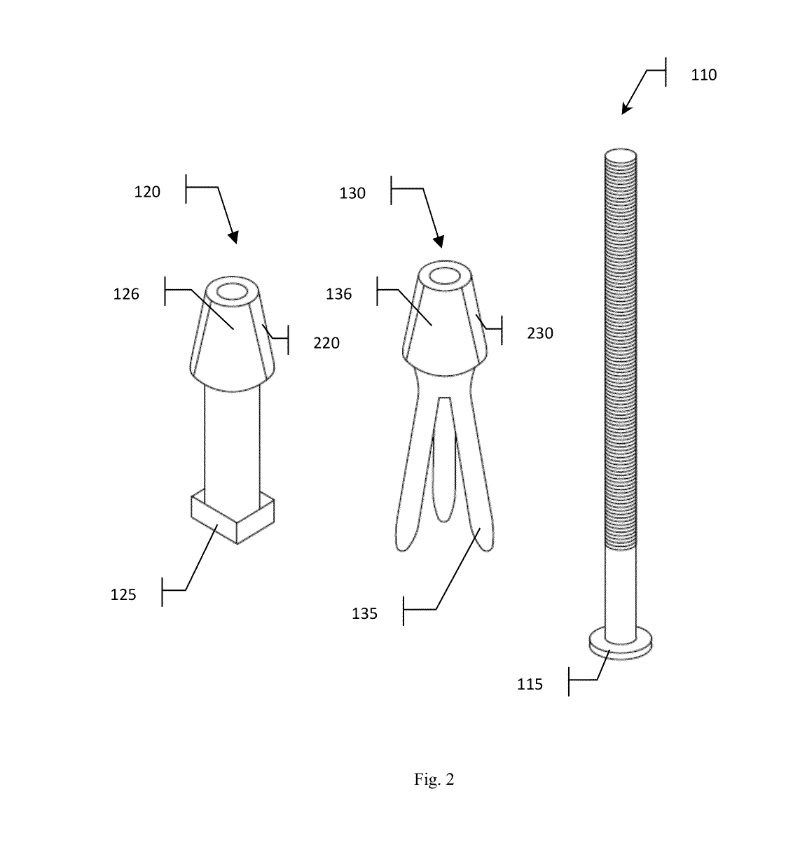

Reference is made now to FIGS. 1 and 2 which present a schematic illustration of the anchor device [100] of the present invention. FIG. 2 presents the separated parts of the anchor device [100] and FIG. 1 presents the composed anchor device [100]. The anchor device [100] of the present invention is configured for securing a screw [110] and a load to an object [310] through or within a pre-formed hole [320]. The structure of the anchor device [100] comprises:
a. a threaded screw [110];
b. a tubular member [120], comprising a plier-grip head [125] at one end, configured to contain the screw's head [115] and to allow the rotation of the screw's head [115]; the member [120] further comprises a guiding-edge [126] at the opposing end, adapted to open the anchor's fixing-petals [135], while compression forces are activated therebetween;
c. at least one threaded tubular anchor [130], each of the anchors [130] comprising at least two spreadable fixing-petals [135] located at one end; the anchors [130] further comprise a guiding-edge [136] at the opposing end, adapted to open the following anchor's fixing-petals [135], while compression forces are activated therebetween.

The member [120] is seated on the screw [110] with the grip-head [125] towards the screw's head [115]. The anchors [130] are seated on the screw [110], following the member [120] and in contact with the member [120] or in contact with the other anchor [130], where the fixing-petals [135] are seated towards the screw's head [115].

The screw's head [115] and the anchors [130] are configured to threadly approach each other, during the screw's [110] rotation, thus creating the compression forces and opening the anchors' fixing-petals [135].

The opened anchor's fixing-petals [135] are adapted to firmly cling the screw [110] to the object [310], by hanging on to the surface inside of the hole [320] or to the surface at the back of the object [310], thereby securing the screw [110] and the load to the object [310].

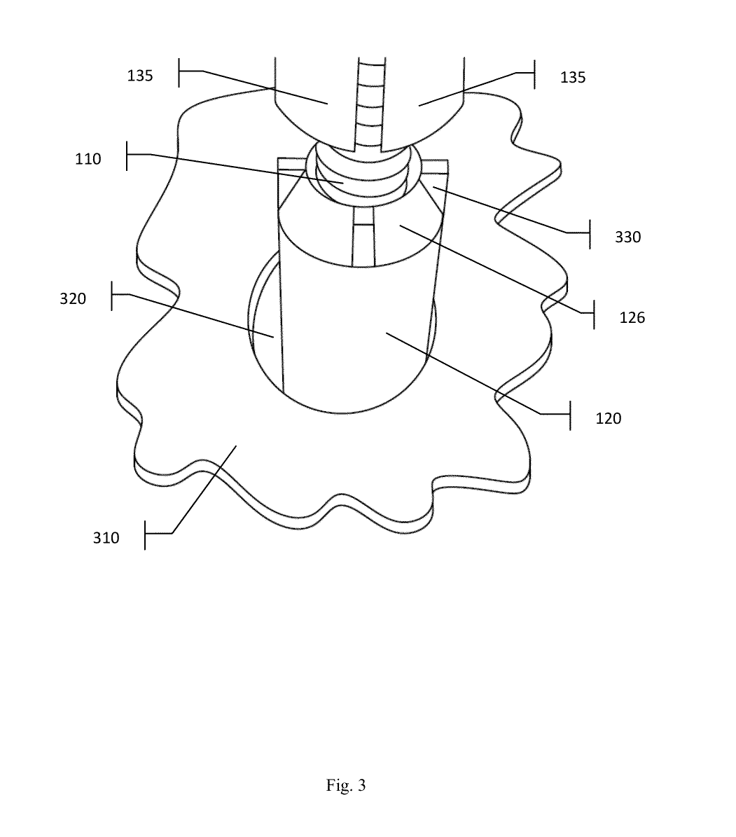

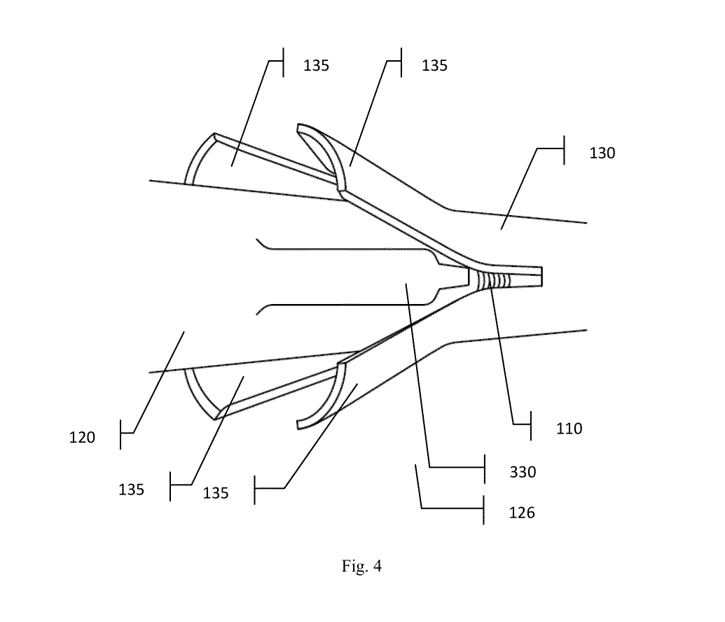

Reference is made now to FIG. 3, which illustrates the guiding-edge [126] of the tubular member [120]. FIG. 3 demonstrates that the member's guiding-edge [126] can be constructed of a truncated-cone with protruding tips [330] also demonstrated in FIGS. 1 and 4 or concave guide-paths [220] which are demonstrated in FIGS. 2 and 7. The protruding tips [330] or concaved guide-paths [220] are adapted to open the anchor's matching fixing-petals [135].

Reference is made now to FIG. 4, which illustrates the opened fixing-petals [135] of the tubular anchor [130]. FIG. 4 demonstrates that by rotating the screw's head [115], while holding the members grip-head [125], the screw's head [115] and the anchors [130] are threadly approaching each other, thereby pushing the tubular member [130] towards the anchor's fixing-petals [135] and creating compression forces. The anchor's fixing-petals [135] are thereby sliding along the body of said member's guiding-edge [126] and being separated and pushed away from the screw [110].

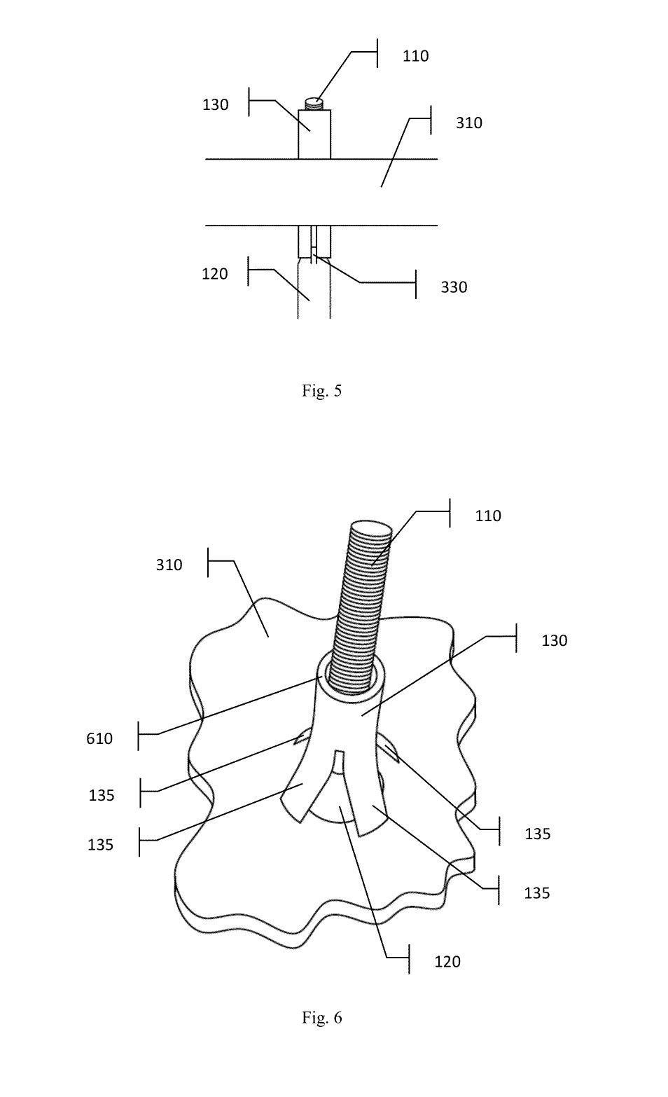

Reference is made now to FIG. 5, which illustrates the anchor device [100] applied through a wall, where the fixing-petals [135] are in a closed position. It is demonstrated that the anchor device [100] can be used for securing a screw and a load to a wall by inserting the anchor device [100] where no nut is required.

Reference is made now to FIG. 6, which illustrates the anchor device [100] applied through a wall, where fixing-petals [135] are in an open position. It is demonstrated that the opened anchor's fixing-petals [135] are adapted to firmly cling the screw [110] to the object [310], by hanging on to the surface at the back of the object [310] or wall, thereby securing the screw [110] and the load to the object [310] or wall.

Reference is made now to FIG. 7, which illustrates the anchor device [100] comprising two following anchors [130] applied within a hole [320], demonstrated after the fixing-petals [135] separation to an open position. It is demonstrated that the opened anchor's fixing-petals [135] are adapted to firmly cling the screw [110] to the object [310], by hanging on to the hole's [320] surface, thereby securing the screw [110] and the load to the object [310] or wall.

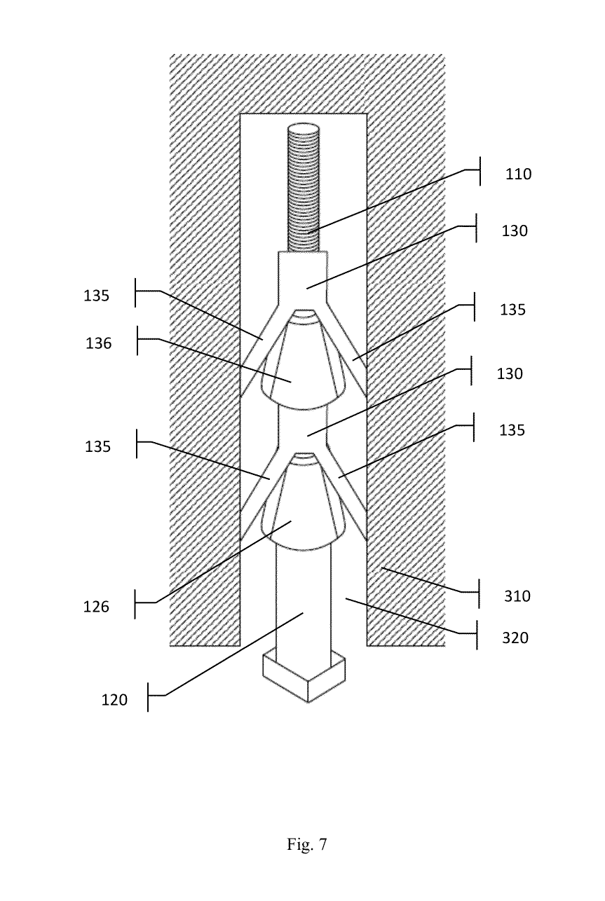

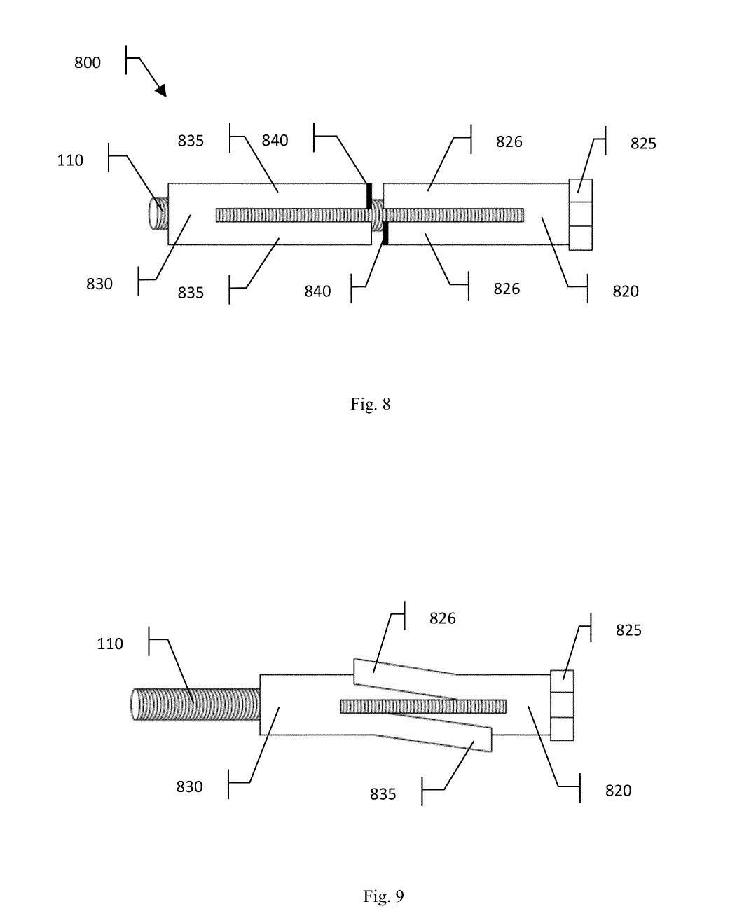

Reference is made now to FIG. 8, which presents a schematic illustration of an anchor device [800] comprising two opposing anchors [820,830], for securing a screw [110] and a load to an object [310] within a pre-formed hole [320] comprising:
a. a threaded screw [110];
b. a first tubular anchor [820], comprising a plier-grip head [825] at one end, configured to contain the screw's head [115] and to allow the rotation of the screw's head [115]; the first anchor [820] further comprises at least two spreadable fixing-petals [826] located the other end; and
c. a second threaded tubular anchor [830], comprising at least two spreadable fixing-petals [835] located at one end.

The first anchor [820] is seated on the screw [110] with the grip-head [825] towards the screw's head [115]. The second anchor [830] is seated on the screw [110], following the first anchor [520] and in contact with the first anchor [820], where the fixing-petals [835] of the second anchor [830] are seated towards the screw's head [115].

The first anchor [820] and the second anchor [830] comprise a matching number of the fixing-petals [826, 835], thereby configured as opposing fixing-petals.

Each of the opposing fixing-petals [826,835] is configured with a beveled edge at their outer-side [840] or at their inner-side [850]. The fixing-petals [826,835] with the outer-side beveled edges [840] are adapted to push the fixing-petals [826,835] with the inner-side beveled edges [850] away from the screw [110], while compression forces are activated therebetween;

The screw's head [115] and second anchor [830] are configured to threadly approach each other, during the screw's [110] rotation, thus creating the compression forces. The protruding opened fixing-petals [826,835] are adapted to firmly cling the screw [110] to the object [310], by hanging onto the surface inside of the hole [320], and thereby secure the screw [110] and the load to the object [310].

Reference is made now to FIG. 9, presents a schematic illustration of the anchors device [800] comprising two opposing anchors [820,830], where fixing-petals [825,836] are in an open position. Once more it is demonstrated that the screw's head [115] and second anchor [830] are configured to threadly approach each other, during the screw's [110] rotation, thus creating the compression forces. The protruding opened fixing-petals [826,835] are adapted to firmly cling the screw [110] to the object [310], by hanging onto the surface inside of the hole [320], and thereby secure the screw [110] and the load to the object [310].

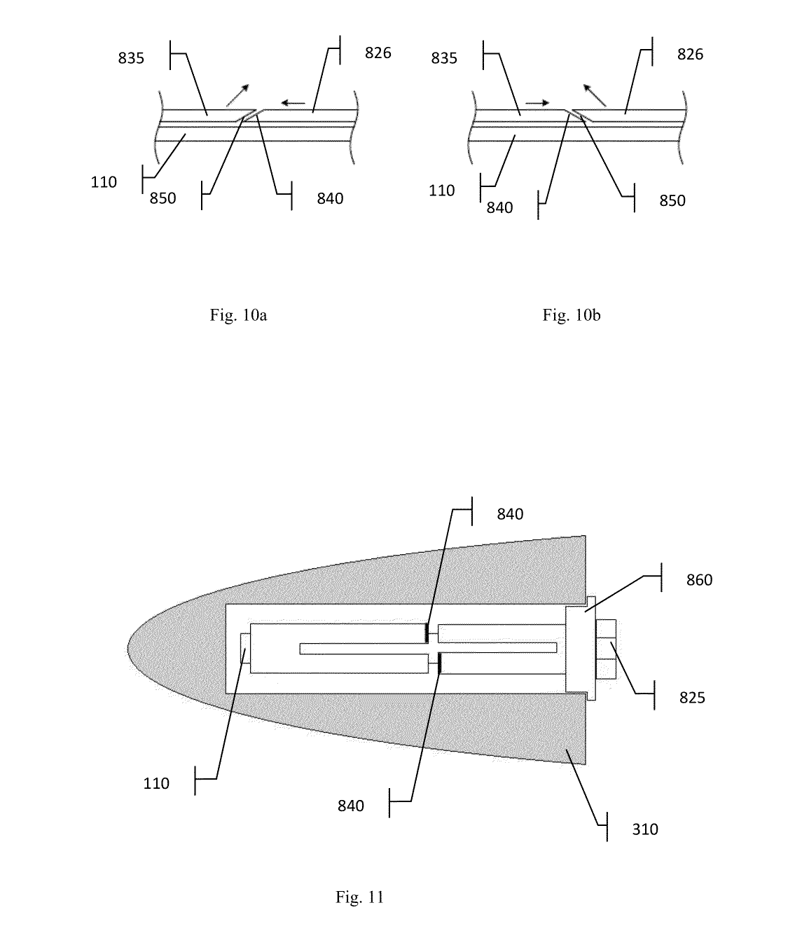

Reference is made now to FIGS. 10a and 10b, which present two sectional illustrations of the beveled fixing-petals [826,835] of the anchor device [800]. Each of the opposing fixing-petals [826,835] is configured with a beveled edge at their outer-side [115] or at their inner-side [850]. The fixing-petals [826,835] with the outer-side beveled edges [840] are adapted to push their matching fixing-petals [826,835] with the inner-side beveled edges [850] away from the screw [110], while compression forces are activated therebetween. The two sectional illustrations 10a and 10b demonstrate that of the opposing fixing-petals [826,835] has either an inner beveled edge [850] or an outer beveled edge [840].

Reference is made now to FIG. 11 which presents a schematic illustration of the anchors device [800], applied within an object's hole, where fixing-petals [825,836] are in a closed position. FIG. 11 further demonstrates the use of a centering collar [860], use to center the anchor device [100] or [800] as in the figure, inside a wide hole [320].

1. An anchor device [100] for securing a screw [110] and a load to an object [310] through or within a pre-formed hole [320] comprising:
a. a threaded screw [110];
b. a tubular member [120], comprising a grip head [125] at one end, configured to contain said screw's head [115] and to allow the rotation of said screw's head [115]; and
c. at least one threaded tubular anchor [130], each of said anchors [130]
comprising at least two spreadable fixing-petals [135] located at one end; said member [120] is seated on said screw [110] with said grip head [125] towards said screw's head [115]; said anchors [130] are seated on said screw [110], following said member [120] and in contact with said member [120] or in contact with said other anchor [130], where said fixing-petals [135] are seated towards said screw's head [115];
wherein said member [120] further comprises a guiding-edge [126] at the opposing end, adapted to open said anchor's fixing-petals [135], while compression forces are activated therebetween; said anchors [130] further comprise a guiding-edge [136] at the opposing end, adapted to open said following anchor's fixing-petals [135], while said compression forces are activated therebetween; said screw's head [115] and said anchors [130] are configured to threadly approach each other, during said screw's [110] rotation, thus creating said compression forces and opening said anchors' fixing-petals [135]; said opened anchor's fixing-petals [135] are adapted to firmly cling said screw [110] to said object [310], by hanging onto the surface inside of said hole [320] or onto the surface at the back of said object [310], thereby securing said screw [110] and said load to said object [310]; further wherein said anchor device [100] is configured for functionality without a securing nut.

2. The anchor device [100] according to claim 1, wherein said anchor [130] is constructed of a tube with at least two slots at one end of said tube, thereby said slots creating said at least two fixing-petals [135].

3. The anchor device [100] according to claim 1, wherein said member's guiding-edge [126] is consisting of a shape selected from the group comprising of: cone, truncated-cone, sphere, truncated-sphere, cylinder, polygon, or any combination thereof.

4. The anchor device [100] according to claim 3, wherein said member's guiding-edge [126] is further consisting of at least two protruding tips [330] or at least two concaved guide-paths [220], adapted to open said anchor's matching fixing-petals and slide said fixing-petals [135] along said guiding-edge [126].

5. The anchor device [100] according to claim 1, wherein said anchor's guiding-edge [136] is consisting of a shape selected from the group comprising of: cone, truncated-cone, sphere, truncated-sphere, cylinder, polygon, or any combination thereof.

6. The anchor device [100] according to claim 5, wherein said anchor's guiding-edge [136] is further consisting of at least two protruding tips [330] or at least two concaved guide-paths [230], adapted to open said following anchor's matching fixing-petals [135] and slide said fixing-petals [135] along said anchor's guiding-edge [136].

7. The anchor device [100] according to claim 1, wherein the ends of said anchor's fixing-petals [135] are beveled at their inner side, for a smother slide along said member's guiding-edge [126] and for an easier penetration into the surface inside of said hole [320] or into the surface at the back of said object [310].

8. The anchor device [100] according to claim 1, wherein said device [100] comprises a single said anchor [130], said anchor constructed without said guiding edge [136] at said opposing end [610].

9. The anchor device [100] according to claim 1, wherein said device [100] is configured in different diameters and lengths, adapted to carry different loads, and to go through different hole [320] lengths.

10. The anchor device [100] according to claim 1, wherein said device [100] is made of a material selected from a group consisting of: metal composite, alloy composite, plastic composite, steel, iron, aluminum, copper composite, or any combination thereof.

11. The anchor device [100] according to claim 1, wherein said inner side of said fixing-petals [135] and the outer of side of said guiding-edge [126,136] of said tubular member [120] or said anchor [130] are made of materials with a static friction coefficient of between about 0.5 and about 0.8.

12. The anchor device [100] according to claim 1, wherein said anchor device [100] is further provided with a centering collar [860].

13. The anchor device [100] according to claim 1, wherein said object [310] is a wall; said wall is a selected from a group consisting of a concrete wall, a gypsum wall, a block wall, a brick wall, a stone wall, or any combination thereof.

14. A method for securing a screw [110] and a load to an object [310] through or within a pre-formed hole [320] comprising the step of:
a. obtaining an anchor device [100] comprising:
i. a threaded screw [110];
ii. a tubular member [120], comprising a plier-grip head [125] at one end, configured to contain said screw's head [115] and to allow the rotation of said screw's head [115]; said member [120] further comprises a guiding-edge [126] at the opposing end, adapted to open said anchor's fixing-petals [135], while compression forces are activated therebetween; and
iii. at least one threaded tubular anchor [130], each of said anchors comprising at least two spreadable fixing-petals [135] located at one end; said anchors [130] further comprise a guiding-edge at the opposing end, adapted to open said following anchor's fixing-petals [135], while said compression forces are activated therebetween;
wherein, said method further comprises the steps of:
b. locating said member [120] on said screw [110] with said grip-head [125] towards said screw's head [115];
c. locating said anchors [130] said screw [110], following said member [120] and in contact with said member [120] or in contact with said other anchor [130], where said fixing-petals [135] are seated towards said screw's head [115];
d. inserting said anchor device [100] into said hole [320] or through said hole [320];
e. screwing said screw's head [115], while holding said members grip-head [125], so as said screw's head [115] and said anchors [130] are threadly approaching each other;
f. pushing said tubular member [130] towards said anchor's fixing-petals [135], thereby creating said compression forces;
g. sliding said anchor's fixing-petals [135] along the body of said member's guiding-edge [126] or along the previous anchor's guiding edge [136];
h. opening said anchors' fixing-petals [135] and pushing away said anchors' fixing-petals [135] from said screw [110], by said compression forces; and
i. clinging said opened anchor's fixing-petals [135] onto the surface inside of said hole [320] or onto the surface at the back of said object [310], thereby securing said screw [110] and said load to said object [310].

15. The method according to claim 14, wherein said anchor [130] is constructed of a tube with at least two slots at one end of said tube, thereby said slots creating said at least two fixing-petals [135].

16. The method according to claim 14, wherein said member's guiding-edge [126] is consisting of a shape selected from the group comprising of: cone, truncated-cone, sphere, truncated-sphere, cylinder, polygon, or any combination thereof.

17. The method according to claim 16, wherein said member's guiding-edge [126] is further consisting of at least two protruding tips [330] or at least two concaved guide-paths [220], adapted to open said anchor's matching fixing-petals [135] and slide said fixing-petals [135] along said guiding-edge [126].

18. The method according to claim 14, wherein said anchor's guiding-edge [136] is consisting of a shape selected from the group comprising of: cone, truncated-cone, sphere, truncated-sphere, cylinder, polygon, or any combination thereof.

19. The method according to claim 18, wherein said anchor's guiding-edge [136] is further consisting of at least two protruding tips [330] or at least two concaved guide-paths [230], adapted to open said following anchor's matching fixing-petals and slide said fixing-petals [135] along said anchor's guiding-edge [136].

20. The method according to claim 14, wherein the ends of said anchor's fixing-petals [135] are beveled at their inner side, for a smother slide along said member's guiding-edge [126] and for an easier penetration into the surface inside of said hole [320] or into the surface at the back of said object [310].

21. The method according to claim 14, wherein said device [100] comprises a single said anchor [130], said anchor constructed without said guiding edge [136] at said opposing end [610].

22. The method according to claim 14, wherein said device [100] is configured in different diameters and lengths, adapted to carry different loads, and to go through different hole [320] lengths.

23. The method according to claim 14, wherein said device [100] is made of a material selected from a group consisting of: metal composite, alloy composite, plastic composite, steel, iron, aluminum, copper composite, or any combination thereof.

24. The method according to claim 14, wherein said inner side of said fixing-petals [135] and the outer of side of said guiding-edge [126,136] of said tubular member [120] or said anchor [130] are made of materials with a static friction coefficient of between about 0.5 and about 0.8.

25. The method according to claim 14, wherein said anchor device [100] is further provided with a centering collar [860].

26. The method according to claim 14, wherein said object [310] is a wall; said wall is a selected from a group consisting of a concrete wall, a gypsum wall, a block wall, a brick wall, a stone wall, or any combination thereof.

27. An anchor device [800] for securing a screw [110] and a load to an object [310] within a pre-formed hole [320] comprising:
a. a threaded screw [110];
b. a first tubular anchor [820], comprising a grip head [825] at one end, configured to contain said screw's head [115] and to allow the rotation of said screw's head [115]; said first anchor [820] further comprises at least two spreadable fixing-petals [826] located the other end; and
c. a second threaded tubular anchor [830], comprising at least two spreadable fixing-petals [835] located at one end;
said first anchor [820] is seated on said screw [110] with said grip head [825] towards said screw's head [115]; said second anchor [830] is seated on said screw [110], following said first anchor [520] and in contact with said first anchor [820], where said fixing-petals [835] of said second anchor [830] are seated towards said screw's head [115]; said first anchor [820] and said second anchor [830] comprise a matching number of said fixing-petals [826,835], thereby configured as opposing fixing-petals;
wherein each of said opposing fixing-petals [826,835] is configured with a beveled edge at their outer-side [840] or at their inner-side [850]; said fixing-petals [826,835] with said outer-side beveled edges [840] are adapted to push said fixing-petals [826,835] with said inner-side beveled edges [850] away from said screw [110], while compression forces are activated therebetween; said screw's head [115] and second anchor [830] are configured to threadly approach each other, during said screw's [110] rotation, thus creating said compression forces;
said protruding opened fixing-petals [826,835] are adapted to firmly cling said screw [110] to said object [310], by hanging onto the surface inside of said hole [320], thereby securing said screw [110] and said load to said object [310]; further wherein said anchor device [800] is configured for functionality without a securing nut.

28. The anchor device [800] according to claim 27, wherein each of said anchors [820,830] are constructed of a tube with at least two slots at one end of said tube, thereby said slots creating said at least two fixing-petals [826,835].

29. The anchor device [800] according to claim 27, wherein said device [800] is configured in different diameters and lengths, adapted to carry different loads, and to go through different hole [320] lengths.

30. The anchor device [800] according to claim 27, wherein said device [800] is made of a material selected from a group consisting of: metal composite, alloy composite, plastic composite, steel, iron, aluminum, copper composite, or any combination thereof.

31. The anchor device [800] according to claim 27, wherein said anchor device [800] is further provided with a centering collar [860].

32. The anchor device [800] according to claim 27, wherein said object [310] is a wall; said wall is a selected from a group consisting of a concrete wall, a gypsum wall, a block wall, a brick wall, a stone wall, or any combination thereof
